(19) United States
(12) Patent Application Publication
(10) Pub. No.: US 2014/0292121 A1
(43) Pub. Date: Oct. 2, 2014

(54) VEHICLE DRIVE ASSEMBLY COMPRISING COOLING BY MEANS OF A HEAT-TRANSFER FLUID AND AIR

(71) Applicants: COMPAGNIE GENERALE DES ETABLISSEMENTS MICHELIN, Clermont-Ferrand (FR); Michelin Recherch et Technique S.A., GRANGES-PACCOT (CH)

(72) Inventors: Daniel Walser, Clermont-Ferrand (FR); Bruno Fragniere, Clermont-Ferrand (FR)

(21) Appl. No.: 14/359,388

(22) PCT Filed: Oct. 16, 2012
(86) PCT No.: PCT/IB2012/002121

§ 371 Date: May 20, 2014

(30) Foreign Application Priority Data
Nov. 22, 2011 (FR) 1103555

(51) Int. Cl. B60K 11/02; H02K 9/20; B60K 7/00

(52) U.S. Cl. CPC B60K 11/02; B60K 7/0007; H02K 9/20
USPC 310/54

(57) ABSTRACT

An electric vehicle drive assembly includes an electric motor mounted to engage with a wheel of a vehicle. The electric motor includes a rotor and a magnetic assembly. The rotor is rotatably mounted in a stator through interposition of an internal rolling bearing, which is positioned near the wheel, and an external rolling bearing, which is positioned at some distance from the wheel. The magnetic assembly is designed to rotationally drive the rotor. The rotor is provided with a heat pipe having at least one condensation zone, for condensing a heat-transfer liquid, and at least one evaporation zone, for evaporating the heat-transfer liquid. The evaporation zone is arranged to extend axially inside the internal rolling bearing.

### TECHNICAL FIELD OF THE INVENTION

The present invention relates to a drive assembly for an electric vehicle, which assembly is comprised of an electric motor mounted to engage with a wheel of the vehicle, to drive the rotation of this wheel when the motor is powered with electrical energy.

### PRIOR ART

Electric motors are now commonplace and their use has now extended to practically all spheres of activity, including the field of transport and notably motor cars. Their excellent efficiency and therefore their low level of fuel consumption, their low noise levels, their compactness, etc., makes them increasingly attractive in an incessantly growing number of applications.

However, certain significant drawbacks still remain despite the appreciable progress that has been made with respect to certain performance aspects. This is particularly the case with the problems connected with the heating up of the motors, particularly in applications requiring prolonged operation and/or high powers. Furthermore, in most electric motors, the rotors are subjected to significant electromagnetically induced heating. The motor shaft may reach very high operating temperatures. Some of the heat energy is removed by conduction, by point contacts with the rolling bearing, from the heart of the motor to the outside of the casing and also by radiation. The hotter things are around the rotor, the lower this heat loss. This leads to a natural increase in rotor temperature.

In electric vehicle drive assemblies like the one depicted for example in FIG. 2, this high temperature has a negative impact on the characteristics of the permanent magnets of the motor, when it has any, and also on the reliability of certain mechanical components such as the rolling bearing and the seal which are situated on the motor output side, in the region of interface with the wheel to which the motor is coupled.

Patent Application WO 2004/107535 proposes a rotary electric machine, notably for a motor vehicle, provided with means of cooling and of removal to the outside of the heat produced in the machine. The cooling and removal means comprise at least a device comprising a heat-transfer fluid capable of absorbing heat from the surroundings through a first state change, and of returning the heat to the surroundings in a further state change, and a path for the circulation of this fluid between a heat production zone and a heat removal zone. This concept can be used for alternators, starters or alternator-starters for motor vehicles. Furthermore, the installations are aimed in particular at removing the heat produced by the rectifier device, notably the diodes. The alternators described are also fitted with fans positioned in such a way as to generate a circuit of cooling air.

That document describes ways of installing a heat pipe that are specific to alternators or to alternator-starters and cannot be reapplied directly to electric vehicle drive assemblies.

In order to alleviate these various disadvantages, the invention provides various technical means.

### SUMMARY OF THE INVENTION

First of all, a first object of the invention is to provide a vehicle drive assembly that encourages effective removal of the heat energy generated during operation.

Another object of the invention is to provide a drive assembly for a vehicle moving around under conditions that promote the life of the seal at the interface between the wheel and the motor and avoids potential premature deterioration of this seal.

To achieve this, the invention provides an electric vehicle drive assembly that includes an electric motor mounted to engage with a wheel of the vehicle, to drive the rotation of the latter when the said motor is powered with electrical energy, the electric motor comprising a rotor mounted with the ability to rotate in a stator through the interposition of an internal rolling bearing near the wheel and of an external rolling bearing some distance from the wheel, and a magnetic assembly provided with a portion mounted on the stator and a portion mounted on the rotor, and designed to drive the rotation of the said rotor, the rotor of the motor being provided with a heat pipe comprising at least one condensation zone for condensing and at least one evaporation zone for evaporating a heat-transfer liquid, the evaporation zone of the heat pipe extending axially inside the internal rolling bearing.

The solution advantageously provides a drive assembly the motor of which comprises one or more heat pipes extending axially from the zone of the rolling bearing and of the seal (evaporation zone near the wheel) towards the condensation zone provided at the output of the motor, on the opposite side from the wheel. The heat pipes serve to collect heat energy from a hot zone and transmit it to the other side, to a cold zone.

The present solution makes it possible to cool not only the magnetic part of the motor but also the portion of the shaft internal to the rolling bearing adjacent to the wheel and internal to the seal.

This solution also makes it possible to improve the removal of heat energy from the hottest zone of the rotor by associating with the rotary assembly a heat exchange means that is reliable and performs well.

The present solution is particularly advantageous as a means for the internal cooling of motor rotors, particularly high performance ones, used for example in electric vehicle drive systems.

According to one advantageous embodiment, the assembly comprises a coupling zone provided with an adaptor and the heat pipe extends through a seal provided between the motor and the adaptor.

According to another advantageous embodiment, the axis of the heat pipe is coaxial with the axis of the rotor.

Advantageously, the condensation zone is located in the zone more or less corresponding to the external rolling bearing of the motor.

Advantageously also, the heat pipe is conical, the wider portion being on the same side as the evaporation zone.

According to another alternative form of embodiment, the heat pipe comprises a reservoir of heat-transfer liquid provided in the region of the evaporation zone.

According to yet another embodiment, the axis of the heat pipe makes an angle (alpha) with respect to the axis of rotation of the rotor.

According to yet another embodiment, a plurality of heat pipes are distributed circumferentially along the periphery of the rotor of the motor.

The invention also provides an electric motor for a drive assembly as mentioned hereinabove, comprising a heat pipe the evaporation zone of which extends axially inside the internal rolling bearing of the motor.

### DESCRIPTION OF THE FIGURES

All the embodiment details are given in the description which follows, supplemented by FIGS. 1 to 8 which are given solely by way of nonlimiting examples and in which:

FIG. 1 is a schematic depiction of the principle of operation of a heat pipe;

FIG. 2 is a cross section through an electric vehicle drive assembly;

FIG. 3 is an enlarged view of a cross section through a drive assembly comprising a heat pipe according to a first embodiment;

FIG. 4 is an enlarged view of a cross section through a drive assembly comprising a heat pipe according to a second embodiment;

FIG. 5 is an enlarged view of a cross section through a drive assembly comprising a heat pipe according to a third embodiment;

FIG. 6 is an enlarged view of a cross section through a drive assembly comprising a heat pipe according to a fourth embodiment;

FIG. 7 is a schematic depiction of a longitudinal section of a heat pipe of conical shape comprising a reservoir of heat-transfer fluid; and

FIG. 6 is a schematic depiction of a longitudinal section of an electric motor rotor or driven shaft for a drive assembly, comprising a plurality of heat pipes distributed about the circumference of the axis.

### DETAILED DESCRIPTION OF THE INVENTION

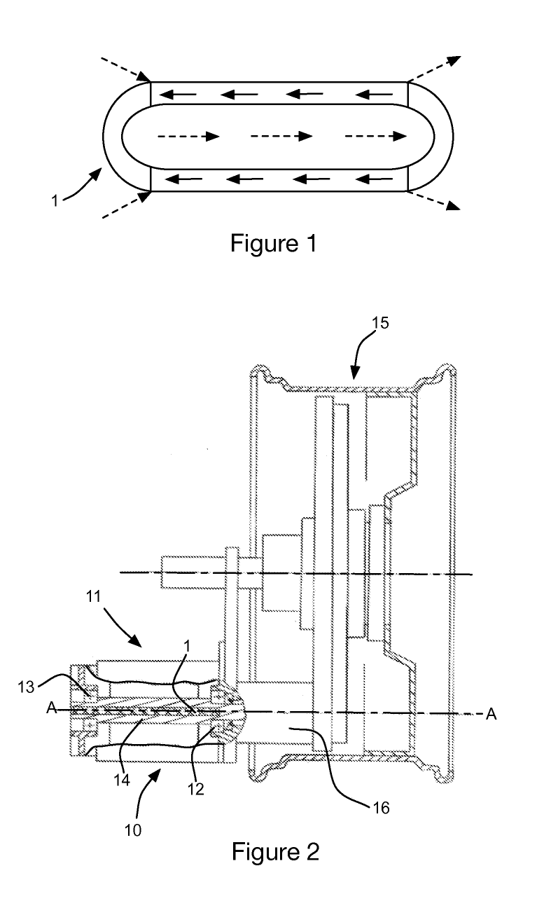

As shown schematically in FIG. 1, a heat pipe 1 is a hermetic space containing a liquid in equilibrium with its vapour phase, generally in the absence of any other gas. The internal wall of this space may be lined with a microporous structure allowing the liquid to return, by capillarity, from the cold zone of the space in which it condenses to the hot part in which it evaporates. This microporous structure allows the liquid to return against the effect of gravity but, in some cases, where the forces applied to the fluid encourage it to return to the evaporator, is unnecessary. The transfer of heat therefore takes place through the conversion of sensible heat into latent heat.

In the absence of any force other than gravity, the return of liquid by capillarity allows the heat pipe to be used in almost any position.

A heat pipe is a reliable system requiring little or no maintenance, lightweight and with low mechanical inertia, and is passive, having the ability to transmit high levels of thermoflux with a small temperature difference and the thermal conductivity of which is several hundred times higher than the thermal conductivity of a copper bar. The heat pipe can operate in all positions (inclined, horizontal) and can be fitted to existing motors.

The active material of the heat pipes, the one that evaporates and condenses, is chosen according to the temperature at which the heat pipe is to operate. Use is made for example of water, ether or alcohol.

The heat pipes are preferably cylindrical in shape, consisting of a tube with good thermal conductivity, if possible made of metal. Copper, which is a very good conductor, is one of the materials used.

The heat pipes may also include a simple hole, which may be blind or open, with heat-transfer liquid, this assembly being hermetically sealed after air has been evacuated.

Various types of heat pipe arrangement are described in what follows for installing a drive assembly according to the invention in the electric motor.

FIG. 2 shows a general arrangement of an electric motor 11 connected with a wheel 15 of a vehicle to form a vehicle drive assembly 10. Such an assembly preferably comprises a coupling zone, in this example an adapter 16, in which the components are in the presence of oil. A seal 20 is provided between the electric motor 11 and the adaptor 16 to prevent oil from passing towards the motor. This seal 20 often is a component likely to deteriorate if the temperature exceeds a certain threshold.

Various solutions to encourage the removal of heat from the motor in general, but also from the region of the seal 20, are set out in what follows.

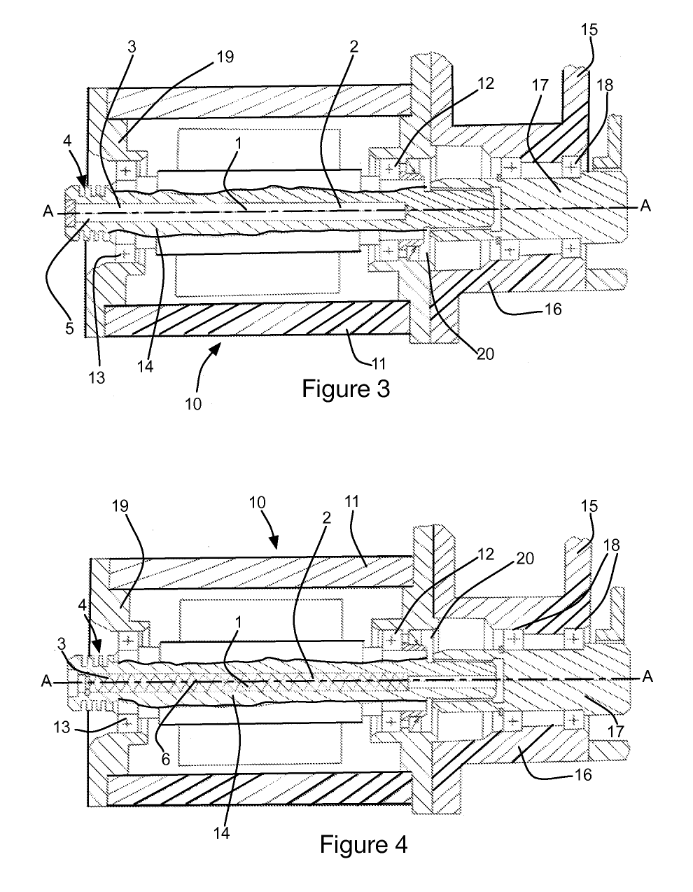

As shown in the cross section of the motor in FIG. 3, a drilling 5, made in the rotor 14, hermetically sealed with a heat-transfer liquid chosen according to the desired operating temperature, constitutes the heat pipe.

The evaporation zone 2 is provided in the zone that is to be cooled, i.e. under the internal rolling bearing 12 and the seal 20, the removal of heat energy taking place at the inlet to the rotor where there were, for example, machined or added-on fins 4 to encourage cooling.

The cross section through the motor of FIG. 4 shows a heat pipe of the insert type 6 housed coaxially with the axis A-A of the rotor 14, the evaporation zone 2 being positioned in the portion that is to be cooled, i.e. inside the internal rolling bearing 12 of the seal 20, heat energy being removed at the inlet to the rotor where there are, for example, machined or added-on fins 4 to encourage cooling. Thermal connection between heat pipe and rotor is afforded by an special high temperature contact compound. Lateral positioning of the heat pipe is afforded, for example, using a washer or stop ring.

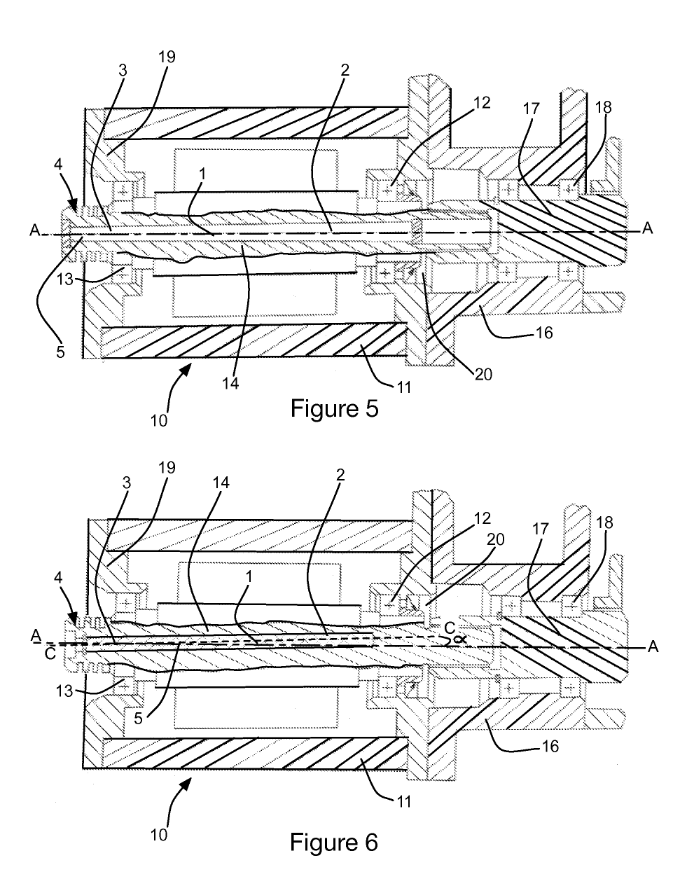

As shown in the cross section of the motor of FIG. 5, a conical drilling 5 machined and hermetically closed with a heat-transfer liquid chosen according to the desired operating temperature, constitutes the heat pipe. The evaporation zone 2 is located inside the portion that is to be cooled, heat being removed from the inlet to the rotor which inlet is modified for better cooling efficiency.

Thanks to the axial component of centrifugal force, the conical shape encourages the return of the heat-transfer fluid to the evaporation zone and thereby improves the efficiency of the system. The cone angle, which takes account of the speed of the motor and the diameter of the drive shaft is advantageously comprised between 0.3 and 2 degrees. In this embodiment, the use of a contact compound and of a position retaining system are not needed.

FIG. 6 illustrates a heat pipe formed in a bore 5 that is inclined by a defined angle (alpha) that takes account of the mechanical strength of the shaft. The angle of inclination (alpha), comprised between 0.3 and 2 degrees, is defined to take account of parameters such as the speed of the motor, the diameter of the heat pipe and the diameter of the rotor.

The evaporation zone 2 of the heat pipe is inside the rotor 14, making it possible to maintain an acceptable temperature radially on the inside of the rolling bearing 12 and of the seal 20. Heat energy is removed at the inlet to the rotor 14 to which is grafted an element that encourages cooling, such as machined or added-on fins 4.

The axial component of centrifugal force which is caused by the inclined position of the heat pipe encourages the return of heat transfer fluid and improves the efficiency of the system. The heat pipe is held in its housing by, for example, a washer or a locking ring. The thermal connection between heat pipe and shaft is afforded by a special high temperature contact compound.

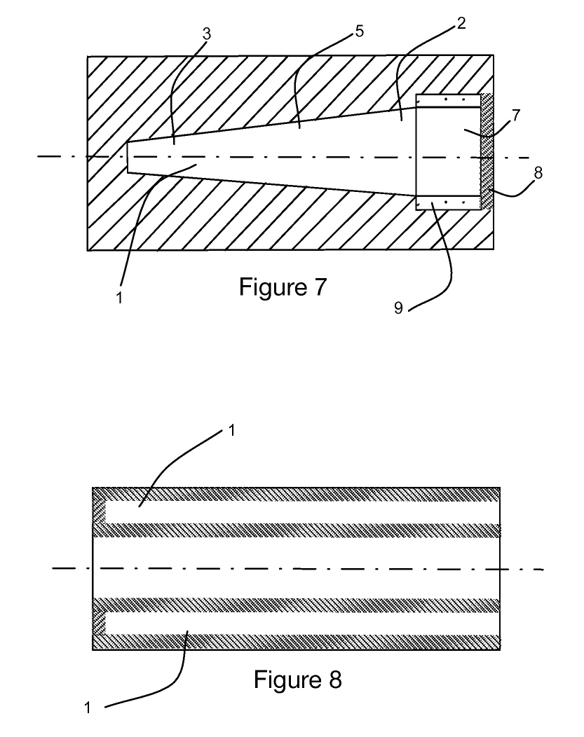

FIG. 7 schematically illustrates the installation of a conical heat pipe of the bore type 5 at the axis of the rotor 14 of the motor that is to be cooled. The evaporation zone 2 comprises a reservoir 7 of cylindrical shape formed at the end of the widened zone of the cone. The rotation and centrifugal force of the shaft entrain the liquid 9 from the reservoir against the walls thereof. Because a large quantity of liquid is available for evaporation, the output of the system is thus improved.

Another embodiment shown in the installation diagram of FIG. 8 comprises a plurality of heat pipes of the bore type 5 provided in the periphery of the rotor of the motor. The presence of several cooling sources distributed around the shaft encourages the removal of heat energy.

The figures and the descriptions thereof given hereinabove illustrate the invention rather than limiting it. In particular, the invention and its various alternative forms have just been described in conjunction with one particular example comprising a drive assembly in which the motor is connected to the wheel at the radially external portion of the wheel.

Nevertheless, it is obvious to a person skilled in the art that the invention can be extended to other embodiments in which, as alternatives, the motor engages with a wheel at a connection point situated at some other radial position, or even at the centre of the wheel.

The reference signs in the claims are entirely nonlimiting. The verbs “comprise”, and “include” do not exclude the presence of elements other than those listed in the claims. The word “a/an” or “one” preceding a component does not exclude there being a plurality of such components.

1-10. (canceled)

11. A drive assembly usable in an electric vehicle, the drive assembly comprising an electric motor mounted to engage with a wheel of the vehicle, to rotationally drive the wheel when the motor is powered with electrical energy,
wherein the motor includes:
a rotor rotatably mounted in a stator through interposition of an internal rolling bearing, which is positioned at a first distance from the wheel, and an external rolling bearing, which is positioned at a second distance from the wheel, the second distance being greater than the first distance, and
a magnetic assembly that includes a portion mounted on the stator and a portion mounted on the rotor, the magnetic assembly being structured to rotationally drive the rotor,
wherein the rotor includes a heat pipe that includes at least: a condensation zone for condensing a heat-transfer liquid and an evaporation zone for evaporating the heat-transfer liquid, and
wherein the evaporation zone extends axially inside the internal rolling bearing.

12. The drive assembly of claim 11, further comprising a coupling zone,
wherein the coupling zone includes an adaptor, and
wherein the heat pipe extends through a seal positioned between the motor and the adaptor.

13. The drive assembly of claim 11, wherein the condensation zone is located in a region that approximately corresponds to the external rolling bearing.

14. The drive assembly of claim 11, wherein the heat pipe is conical and includes a wider portion located on a same side as the evaporation zone.

15. The drive assembly of claim 11, wherein the heat pipe includes a reservoir for holding the heat-transfer liquid, the reservoir being provided in a region of the evaporation zone.

16. The drive assembly of claim 11, wherein an axis of the heat pipe is coaxial with an axis of the rotor.

17. The drive assembly of claim 11, wherein an axis (C-C) of the heat pipe makes an angle (alpha) with respect to an axis of rotation (A-A) of the rotor.

18. The drive assembly of claim 11,
wherein the heat pipe is one of a plurality of heat pipes of the motor, and
wherein the heat pipes are distributed circumferentially along a periphery of the rotor.
